(19) United States
(12) Patent Application Publication
(10) Pub. No.: US 2009/0211429 A1
(43) Pub. Date: Aug. 27, 2009

(54) Drum

(75) Inventor: Wu-Hong Hsieh, Lu Chou City (TW)

Correspondence Address: COOPER & DUNHAM, LLP, 30 Rockefeller Plaza, 20th Floor, NEW YORK, NY, 10112, US

(73) Assignee: K.H.S. Musical Instrument Co., Ltd.

(21) Appl. No.: 12/072,211

(22) Filed: Feb. 25, 2008

(51) Int. Cl. G10D 13/02

(52) U.S. Cl. 84/411 R

(57) ABSTRACT

A drum has a drum shell, a top head, a bottom head and a decorating piece. The drum shell has an outer surface, a top edge, a bottom edge and an annular recess. The top head is mounted at the top edge of the drum shell and the bottom head is mounted at the bottom edge of the drum shell. The annular recess is formed on the outer surface of the drum shell. The decorating piece is glued or screwed in the annular recess and is made of a material different from that of the drum shell. The decorating piece fits in the annular recess. Therefore, the drum shell with the decorating piece is a complex material structure, so the drum changes various resonance and artistic effects.

### BACKGROUND OF THE INVENTION

1. Field of the Invention

The present invention relates to a drum, especially, relates to a drum having a drum shell made of complex materials.

2. Description of the Related Art

Drum is one of the most important instruments in percussion. With reference to FIG. 4, a drum (2) has a top head (22), a bottom head (23) and a drum shell (21).

The drum shell (21) has an outer surface, a top edge and a bottom edge. The top head (22) of the drum (2) is mounted at the top edge of the drum shell (21) and the bottom head (23) of the drum (2) is mounted at the bottom edge of the drum shell (21). When the drum (2) is in use, the top head (22) or the bottom head (23) is hit and the drum shell (21), the top head (22) and the bottom head (23) are resonated in the same time for generating sounds.

The drum shell (21) of the drum (2) can provide resonance effects, and the outer surface of the drum shell (21) also provides an artistic effect. However, the drums use the same drum shell (21) to merely generate a single variation of materials so provides a fixed resonance effect.

### SUMMARY OF THE INVENTION

The main objective of the present invention is to provide a drum made of complex materials.

To achieve the foregoing objective, a drum in accordance with the present comprises a drum shell, a top head, a bottom head and a decorating piece. The drum shell has an outer surface, a top edge, a bottom edge and an annular recess. The top head is mounted at the top edge of the drum shell and the bottom head is mounted at the bottom edge of the drum shell. The annular recess is formed on the outer surface of the drum shell. The decorating piece is glued or screwed in the annular recess and is made of a material different from that of the drum shell. The decorating piece fits in the annular recess. Therefore, the drum shell with the decorating piece is a complex material structure, so the drum changes various resonance and artistic effects.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a drum in accordance with the present invention;

FIG. 2 is a perspective view of a drum shell of the drum in FIG. 1;

FIG. 3 is a cross-sectional side view in partial of the drum shell in FIG. 1; and

FIG. 4 is a perspective view of a drum in accordance with the prior art.

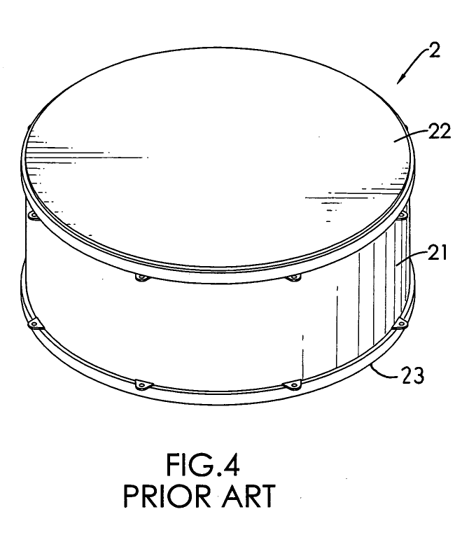

### DETAILED DESCRIPTION OF THE PREFERRED EMBODIMENTS

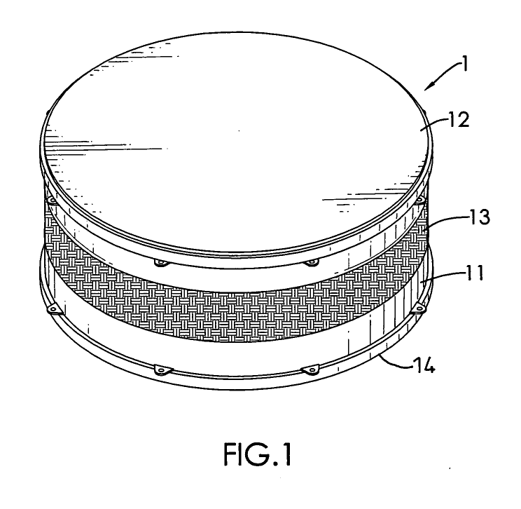

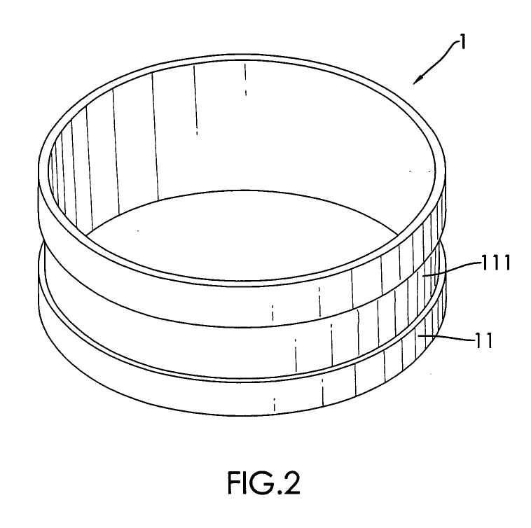

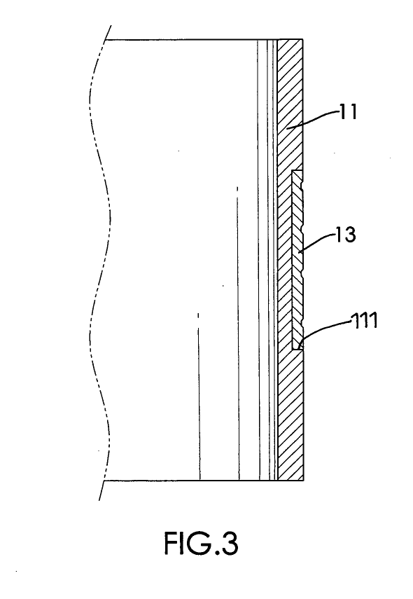

With reference to FIGS. 1, 2 and 3, a drum (1) in accordance of the present invention comprises a drum shell (11), a top head (12), a bottom head (14) and a decorating piece (13).

The drum shell (11) has an outer surface, a top edge, a bottom edge and an annular recess (111). The drum shell (11) may be wood, metal (ex: iron or copper), plastic or rubber etc material. The annular recess (111) is formed in the outer surface of the drum shell (11). In the preferred embodiment, a width of the annular recess (111) is smaller than a width of the outer surface and formed in a middle position of the outer surface.

The top head (12) of the drum (1) is mounted at the top edge of the drum shell (11), and the bottom head (14) of the drum (1) is mounted at the bottom edge of the drum shell (11).

The decorating piece (13) is mounted in the annular recess (111) of the drum shell (11). The decorating piece (13) may be glued or screwed in the annular recess (111) of the drum shell (11). The decorating piece (13) is made of a material different from that of the drum shell (11) and may be leather, metal, plastic or rubber etc. material. The decorating piece (13) may fit in the annular recess (111) of the drum shell (11). In the preferred embodiment, a thickness of the decorating piece (13) slightly same as a depth of the annular recess, so the decorating piece (13) flushes with the outer surface of the drum shell (11). Therefore, the drum shell is a complex material structure and provides an improved artistic effect.

When the top head (12) or the bottom head (14) is hit, the drum shell (11), the top head (12) and the bottom head (14) are resonated to generate sounds. Because the decorating piece (13) and the drum shell (11) are different materials, the resonance effect of the drum is changed.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A drum comprising:
a drum shell having
an outer surface;
a top edge;
a bottom edge; and
an annular recess being formed in the outer surface of the drum shell;
a top head being mounted at the top edge of the drum shell;
a bottom head being mounted at the bottom edge of the drum shell; and
a decorating piece being mounted in the annular recess of the drum shell, wherein the decorating piece is made of a material different from that for the drum shell.

2. The drum as claimed in claim 1, wherein a width of the annular recess is smaller than a width of the outer surface.

3. The drum as claimed in claim 2, wherein the annular recess is formed in a middle position of the outer surface.

4. The drum as claimed in claim 3, wherein the decorating piece flushes with the outer surface of the drum shell.

5. The drum as claimed in claim 4, wherein the drum shell is made of wood, metal, plastic or rubber.

6. The drum as claimed in claim 4, wherein the decorating piece is made of leather, metal, plastic or rubber.

7. The drum as claimed in claim 5, wherein the decorating piece is made of leather, metal, plastic or rubber.
